(19) United States
(12) Patent Application Publication
(10) Pub. No.: US 2026/0188800 A1
(43) Pub. Date: Jul. 2, 2026

(54) FILM FOR CELL POUCH WITH SURFACE TREATMENT LAYER HAVING CONTROLLED CAPILLARY NUMBER AND METHOD OF MANUFACTURING THE SAME

(71) Applicant: YOULCHON CHEMICAL CO., LTD., Seoul (KR)

(72) Inventors: Nok Jung SONG, Seoul (KR); Hee Sik Han, Ansan-si (KR); Ji Min Lee, Ansan-si (KR); Han Chul Park, Ansan-si (KR)

(73) Assignee: YOULCHON CHEMICAL CO., LTD., Seoul (KR)

(21) Appl. No.: 19/316,172

(22) Filed: Sep. 2, 2025

(30) Foreign Application Priority Data
Dec. 26, 2024 (KR) 10-2024-0196630

(51) Int. Cl. H01M 50/129; H01M 50/105; H01M 50/119; H01M 50/121

(52) U.S. Cl. CPC H01M 50/129; H01M 50/105; H01M 50/119; H01M 50/121

(57) ABSTRACT

The present disclosure provides a film for a cell pouch including a first resin layer, a metal layer, and a second resin layer, in which a surface treatment layer is included between the first resin layer and the metal layer, and the surface treatment layer has a capillary number of 0.5 to 5. The present disclosure also provides a method for manufacturing a film for a cell pouch including a first resin layer, a metal layer, and a second resin layer, the method including: forming a surface treatment layer on the metal layer and forming the first resin layer on the surface treatment layer, in which the surface treatment layer has a capillary number of 0.5 to 5.

### CROSS-REFERENCE TO RELATED APPLICATION

This application claims the priority of Korean Patent Application No. 10-2024-0196630 filed on Dec. 26, 2024, in the Korean Intellectual Property Office, the disclosure of which is incorporated herein by reference.

### BACKGROUND

### Field

The present disclosure relates to a film for a cell pouch including a surface treatment layer having a controlled capillary number and a method for manufacturing the same.

### Description of the Related Art

A pouch-type lithium secondary battery has a structure in which electrodes and an electrolyte are contained and sealed in a pouch formed of a thin and flexible plastic film and metal foil. Such a structure has been widely used in various devices, such as electric vehicles, smartphones, and laptops, due to advantages of having a lightweight and high energy density, and being designed in various shapes.

A cell pouch film is used as an exterior material of these pouch-type lithium secondary batteries. The cell pouch film is a critical component that determines the safety and performance of lithium-ion batteries. A general cell pouch film is formed in a multilayer structure, and primarily consists of a protective layer, a metal layer (aluminum), an adhesive layer, and an inner base layer. One of the major problems in a current cell pouch film manufacturing process is caused by bubbles generated between the protective layer and the metal layer. These bubbles may be generated by various causes. As environmental factors, changes in temperature and humidity may affect the viscosity and the coating performance of an adhesive. As material-related problems, dust, impurities, and inadequate surface tension of the film may cause bubble formation. As adhesive-related problems, improperly prepared adhesives or viscosity outside an optimal range may cause coating ununiformity. During the coating and drying process, air may be trapped by an insufficient coating amount or ununiform distribution to form bubbles. These bubbles may deteriorate the performance of the cell pouch film and have a negative effect on the safety and lifespan of a battery in the long term. Therefore, minimizing bubble formation is a critical issue in the film in the cell pouch manufacturing process.

To date, various methods have been attempted to solve these problems. For example, methods for controlling a work environment, strengthening material quality control, optimizing adhesives, and improving coating precision have been used. However, these methods each have limitations and do not offer a complete solution.

### PRIOR ART

### Patent Document

Korean Patent Registration No. 10-2665240

### SUMMARY

An object to be solved by the present disclosure is to provide a film for a cell pouch including a surface treatment layer having a controlled capillary number and a method for manufacturing the same, thereby improving the performance of the manufactured film for the cell pouch.

In order to solve the object, the present disclosure provides a film for a cell pouch including a first resin layer, a metal layer, and a second resin layer, in which a surface treatment layer is disposed between the first resin layer and the metal layer, and the surface treatment layer has a capillary number of 0.5 to 5.

Further, the present disclosure also provides a method for manufacturing a film for a cell pouch including a first resin layer, a metal layer, and a second resin layer, the method including: forming a surface treatment layer on the metal layer and forming the first resin layer on the surface treatment layer, in which the surface treatment layer has a capillary number of 0.5 to 5.

According to the film for the cell pouch and the manufacturing method thereof of the present disclosure, it is possible to effectively reduce a bubble generation rate between the metal layer and the first resin layer by controlling the capillary number of the surface treatment layer included between the first resin layer and the metal layer and to improve the peel strength and electrolyte resistance of the film for the cell pouch by reducing these bubbles.

### BRIEF DESCRIPTION OF THE DRAWING

The above and other aspects, features and other advantages of the present disclosure will be more clearly understood from the following detailed description taken in conjunction with the accompanying drawings, in which:

FIG. 1 is a schematic diagram illustrating the generation of bubbles in a film for a cell pouch according to an embodiment of the present disclosure; and

FIGS. 2 to 5 are photographs for calculating bubble generation rates of Examples and Comparative Examples of the present disclosure.

### DETAILED DESCRIPTION

Hereinafter, various embodiments of the present disclosure will be described in detail with reference to the accompanying drawings. The present disclosure is not limited to specific embodiments, and it should be understood to include various modifications, equivalents, and/or alternatives to the embodiments of the present disclosure. In connection with the description of the drawings, similar reference numerals may be used for similar components.

In this specification, expressions such as “have”, “may have”, “include”, or “may include” refer to the presence of the corresponding feature (e.g., components such as numerical values, functions, operations, or components), and do not exclude the presence of additional features.

In the present disclosure, the expression such as “A or B”, “at least one of A or/and B”, or “one or more of A or/and B” may include all possible combinations of items listed together. For example, “A or B”, “at least one of A and B”, or “one or more of A or B” may refer to all cases of (1) including at least one A, (2) including at least one B, or (3) including both at least one A and at least one B.

The expression of “configured to” used herein may be changed and used to, for example, “suitable for”, “having the capacity to”, “designed to”, “adapted to”, “made to” or “capable of”, depending on a situation. The term of “configured to” does not necessarily mean only “specially designed to”.

The terms used herein are used to illustrate only specific embodiments, and may not be intended to limit the scope of other embodiments. A singular expression may include a plural expression unless the context clearly indicates otherwise. The terms used herein, including technical or scientific terms, may have the same meaning as generally understood by those of ordinary skill in the art described in the present disclosure. The terms defined in a general dictionary among the terms used herein may be interpreted in the same or similar meaning as or to the meaning on the context of the related art, and will not be interpreted as an ideal or excessively formal meaning unless otherwise defined in the present disclosure. In some cases, even the terms defined in the present disclosure may not be interpreted to exclude the embodiments of the present disclosure.

The embodiments disclosed in the present disclosure are presented for explanation and understanding of the disclosed technical contents, and do not limit the scope of the present disclosure. Therefore, the scope of the present disclosure should be interpreted as including all changes or various other embodiments based on the technical idea of the present disclosure.

Hereinafter, a preferred embodiment of the present disclosure will be described in detail. Terms and words used in the present specification and claims should not be interpreted as being limited to typical or dictionary meanings, but should be interpreted as having meanings and concepts which comply with the technical spirit of the present disclosure, based on the principle that an inventor may appropriately define the concept of the term to describe his/her own invention in the best manner.

Therefore, the configurations of the embodiments described in the present specification are merely the most preferred embodiment of the present disclosure and are not intended to represent all of the technical ideas of the present disclosure, and thus, it should be understood that there are various equivalents and modifications capable of replacing the configurations at the time of this application.

Throughout the specification, when a part “includes” a component, unless otherwise specifically stated, it is meant to further include other components rather than excluding other components.

Hereinafter, the present disclosure will be described in detail.

As used in the present disclosure, the term “cell” refers to a battery, and has the broadest meaning, encompassing all types of batteries, such as secondary batteries such as lithium-ion batteries and lithium polymer batteries, and portable storage batteries.

As used in the present disclosure, the term “cell pouch” refers to a pouch in which cell components including a positive electrode, a negative electrode, a separator, etc. are impregnated and stored in an electrolyte, and has the broadest meaning, encompassing all laminated films, processed into pouches or boxes, considering gas barrier properties, bendability, electrolyte resistance, and thermal sealing properties to store the cell components.

The cell pouch-type battery specifically refers to a lithium secondary battery, and means a battery which contains a high-molecular polymer electrolyte and generates current through the movement of lithium ions, and refers to a battery using a film for a cell pouch, in which a polymer and metal are laminated, as an exterior packaging material to protect such a secondary battery. Such a film for the cell pouch is configured in the form in which a metal layer is interposed to protect a battery cell consisting of an electrode assembly and an electrolyte filled therein through a subsequent process, and to stably maintain the electrochemical properties and the like of the cell, and a first resin layer (outer resin layer) may be formed on the metal layer to protect the battery cell from external impacts.

In the film for the cell pouch, an upper cell pouch film and a lower cell pouch film are bonded by thermal bonding and the like at the outer peripheral portion, and a second resin layer (adhesive resin layer) may be formed between the a lower surface of the upper cell pouch film and an upper surface of the lower cell pouch film for mutual interface adhesion.

The present disclosure provides a film for a cell pouch including a first resin layer, a metal layer, and a second resin layer, in which a surface treatment layer is included between the first resin layer and the metal layer, and the surface treatment layer has a capillary number of 0.5 to 5.

Each component of the present disclosure will be described below in detail.

In the method for manufacturing the film for the cell pouch of the present disclosure, the first resin layer is preferably an insulating resin, corresponding to a portion directly contacting hardware. Therefore, the resin used for the first resin layer is preferably at least one of a polyester resin and a polyamide resin. The first resin layer may also be formed as a single layer or as a multilayer.

Specific examples of the polyester resin may include polyethylene terephthalate (PET), polybutylene terephthalate (PBT), polyethylene naphthalate (PEN), polybutylene naphthalate (PBN), copolymerized polyester, polycarbonate (PC), etc. Specific examples of the polyester may include copolymerized polyesters with polyethylene terephthalate, polybutylene terephthalate, polyethylene naphthalate, polybutylene naphthalate, polyethylene isophthalate, polycarbonate, and ethylene terephthalate as main repeating units, copolymerized polyesters with butylene terephthalate as a main repeating unit, and the like.

In addition, specific examples of the copolymerized polyester with ethylene terephthalate as the main repeating unit may include a copolymerized polyester with ethylene terephthalate as the main repeating unit and polymerized with ethylene isophthalate, polyethylene (terephthalate/isophthalate), polyethylene (terephthalate/adipate), polyethylene (terephthalate/sodium sulfoisophthalate), polyethylene (terephthalate/sodium isophthalate), polyethylene (terephthalate/phenyl-dicarboxylate), polyethylene (terephthalate/decanedicarboxylate), etc.

In addition, specific examples of the copolymerized polyester with butylene terephthalate as the main repeating unit may include a copolymerized polyester with butylene terephthalate as the main repeating unit and polymerized with butylene isophthalate, polybutylene (terephthalate/adipate), polybutylene (terephthalate/sebacate), polybutylene (terephthalate/decanedicarboxylate), polybutylene naphthalate, and the like. These polyesters may be used alone or in combination of two or more.

Specific examples of the polyamide resin may include aliphatic polyamides, such as nylon 6, nylon 66, nylon 610, nylon 12, nylon 46, and a copolymer of nylon 6 and nylon 66; aromatic-containing polyamides, such as hexamethylenediamine-isophthalic acid-terephthalic acid copolymer polyamides such as nylon 6I, nylon 6T, nylon 6IT, and nylon 616T (I represents isophthalic acid, and T represents terephthalic acid) containing structural units derived from terephthalic acid and/or isophthalic acid, and polymethaxylene adipamide (MXD6); alicyclic polyamides such as polyaminomethylcyclohexyl adipamide (PACM6); polyesteramide copolymers or polyetheresteramide copolymers, which are copolymers of polyamides copolymerized with a lactam component or an isocyanate component such as 4,4′-diphenylmethane-diisocyanate, and a copolymer of copolymerized polyamide and polyester or polyalkylene ether glycol; copolymers thereof, and the like. These polyamides may be used alone or in combination of two or more.

When the thickness of the first resin layer is less than the above range, physical properties are deteriorated and thus the first resin layer may tear easily, and when the thickness of the first resin layer exceeds the above range, there is a problem in that formability is deteriorated.

The first resin layer may optionally be a multilayer. For example, a polyester resin layer may be formed on the outermost layer of the film for the cell pouch, and a polyamide resin layer may be formed inside the polyester resin layer.

The thickness of the first resin layer may be 10 to 30 μm when the first resin layer is a single layer. For example, the thickness of the first resin layer may be 10 μm or more, 11 μm or more, 12 μm or more, 13 μm or more, 14 μm or more, 15 μm or more, 30 μm or less, 29 μm or less, 28 μm or less, 27 μm or less, 26 μm or less, or 25 μm or less. The thickness of the first resin layer may be 20 to 55 μm when the first resin layer is a multilayer of two or more layers. For example, when the first resin layer is the multilayer of two or more layers, the thickness may be 20 μm or more, 21 μm or more, 22 μm or more, 23 μm or more, 25 μm or more, 26 μm or more, 27 μm or more, 28 μm or more, 29 μm or more, 30 μm or more, 50 μm or less, 49 μm or less, 48 μm or less, 47 μm or less, 46 μm or less, 45 μm or less, 44 μm or less, 43 μm or less, 42 μm or less, 41 μm or less, or 40 μm or less.

The metal layer may be in the form of a metal thin film, which is used as a barrier layer to prevent the penetration of oxygen or moisture from the outside. The metal layer may specifically include at least one selected from the group consisting of aluminum (Al), iron (Fe), copper (Cu), nickel (Ni), stainless steel (SUS), tin (Sn), zinc (Zn), indium (In), tungsten (W), titanium (Ti), and invar (INVAR).

The material of the metal layer is preferably aluminum or stainless steel. An aluminum alloy may be used with alloys with various metals and non-metals added to pure aluminum. The aluminum layer may preferably be used with a soft aluminum foil.

The aluminum base material may optionally be an alloy including an element selected from the group consisting of silicon, boron, germanium, arsenic, antimony, copper, magnesium, manganese, zinc, lithium, iron, chromium, vanadium, titanium, bismuth, potassium, tin, lead, zirconium, nickel, cobalt, and combinations thereof.

The stainless steel is an iron-based alloy and may be manufactured to have properties suitable for specific applications through a combination of various elements. The iron (Fe) is a basic element of stainless steel, forms the matrix of the alloy and provides structural strength and ductility. The chromium (Cr) is a key element in stainless steel, and is contained in a minimum of 10.5% or more to form a protective oxide film on the surface, thereby preventing corrosion. The nickel (Ni) improves strength, ductility, and toughness, and may provide high-temperature resistance. The carbon (C) may serve to increase strength and hardness. The molybdenum (Mo) enhances corrosion resistance, especially in a chloride-containing environment, and may improve high-temperature strength and creep resistance. The manganese (Mn) improves strength and may serve to replace nickel in some grades. The nitrogen (N) may also help improving strength. The titanium (Ti) and niobium (Nb) may serve to improve stability in specific grades.

The stainless steel may be classified primarily into austenitic, ferritic, martensitic, and duplex types according to a metal structure. The austenitic types are the most widely used, and may include, for example, grades 304 and 316. Grade 304 contains 18% chromium and 8% nickel, while grade 316 is further added with molybdenum to have higher corrosion resistance. The ferritic types have high chromium content and little nickel content, and are widely used due to their cost-effectiveness. Grade 430 is a representative example. The martensitic types may increase the strength and hardness through heat treatment, and may include, for example, grades 410 and 420. The duplex types have mixed austenitic and ferritic structures, and thus are characterized by having both high strength and excellent corrosion resistance. Grades 2205 and 2507 may be exemplified.

The metal foil used in the metal layer may etch or degrease the surface to improve adhesion with the second resin layer to be described below, but may be omitted to reduce the process speed. The metal layer is intended to prevent gas and water vapor from penetrating into the battery from the outside, and thus, it is necessary to have no pinhole and processing quality (pouching, embossing) of the metal layer.

According to an embodiment of the present disclosure, the metal layer may satisfy at least one of the following conditions (1) to (3):
(1) a surface roughness (Ra) value of the metal layer of 0.2 μm or greater,
(2) a surface roughness (Rt) value of the metal layer of 1.5 μm or greater, and
(3) a surface roughness (Rz) value of the metal layer of 2.0 μm or greater.

The surface roughness is an indicator quantitatively representing the fine irregularities on a surface. The surface roughness means measuring and analyzing the degree of surface roughness caused by small deposits, crystals, curvatures, etc. present on the surface. The surface roughness is expressed through various parameters, and the parameters of the surface roughness refer to Ra (arithmetic mean roughness), Rt (total height), and Rz (ten-point mean roughness).

The metal layer used in the manufacture of the cell pouch film may be included within the surface roughness range described above. In the related art, as the surface thereof is smooth by performing a separate surface roughness treatment to the metal layer of the cell pouch film, a bubble generation rate may be reduced during bonding to the first resin layer to be described below. However, since additional processes for surface roughness treatment are required or the rising cost of the metal layer during surface roughness treatment may be caused, the bubble generation rate may be dramatically reduced by introducing the surface treatment layer according to an embodiment of the present disclosure onto the metal layer.

A corrosion-prevention treatment layer may be further formed on the metal layer. The corrosion-prevention treatment layer is fundamentally a layer formed to prevent corrosion of an aluminum foil layer due to an electrolyte or hydrofluoric acid.

Examples of corrosion-prevention treatment may include degreasing, hydrothermal modification, anodizing, chemical treatment, coating-type corrosion prevention treatment of applying and constructing a coating agent with corrosion prevention properties, or a combination of two or more of these treatments.

The thickness of the metal layer may be 10 to 100 μm, considering processability, oxygen and moisture blocking properties, etc. For example, the thickness of the metal layer may be 10 μm or more, 11 μm or more, 12 μm or more, 13 μm or more, 14 μm or more, 15 μm or more, 16 μm or more, 20 μm or more, 21 μm or more, 25 μm or more, 100 μm or less, 90 μm or less, 85 μm or less, 80 μm or less, 75 μm or less, 70 μm or less, 69 μm or less, 68 μm or less, 67 μm or less, 66 μm or less, or 65 μm or less. When the above range is not satisfied, if the thickness is less than 10 μm, the metal layer is easily torn, and the electrolytic resistance and insulation are deteriorated, and if the thickness exceeds 100 μm, there is a problem of deterioration in formability.

In the film for the cell pouch of the present disclosure, the second resin layer corresponds to the innermost layer and a layer which seals a battery element by thermal bonding between the inner resin layers during battery assembly. The second resin layer may also be formed as a single layer or also be formed as a multilayer.

The second resin layer is not particularly limited as long as it is thermal bondable, but may consist of a resin layer including at least one selected from the group consisting of polyolefins, polybutylenes, ethylene copolymers, propylene copolymers, polyesters, polyamides, polycarbonates, fluorines, silicones, cyclic polyolefins, carboxylic acid-modified cyclic polyolefins, acrylics, ethylene-propylene-diene-monomer rubber (EPDM), and polyolefin ketone copolymers.

Specific examples of the polyolefin may include polyethylenes, such as low-density polyethylene, medium-density polyethylene, high-density polyethylene, and linear low-density polyethylene; polypropylenes, such as homopolypropylene, block copolymers of polypropylene (e.g., block copolymer of propylene and ethylene), random copolymers of polypropylene (e.g., random copolymer of propylene and ethylene); terpolymers of ethylene-butene-propylene; and the like. Among these polyolefins, polyethylene or polypropylene is preferable. Further, the polypropylene may be casting polypropylene (cPP). When polyolefin such as polyethylene or polypropylene is used for the inner resin layer, the film may have properties required as a packaging material for a secondary battery, such as good heat sealability, moisture resistance, and heat resistance.

The second resin layer may optionally be a multilayer. For example, the second resin layer may be formed by laminating an inner layer of extruded polypropylene (PP) and an outermost layer of casting polypropylene (cPP).

The thickness of the second resin layer may be 20 to 100 μm in consideration of formability, insulation, electrolyte resistance, and the like. For example, the thickness of the second resin layer may be 20 μm or more, 25 μm or more, 30 μm or more, 35 μm or more, 40 μm or more, 41 μm or more, 42 μm or more, 43 μm or more, 44 μm or more, 45 μm or more, 100 μm or less, 95 μm or less, 90 μm or less, 89 μm or less, 88 μm or less, 87 μm or less, 86 μm or less, or 85 μm or less. When the above range is not satisfied, there may be a problem in that formability, insulation, and electrolyte resistance are deteriorated.

The surface treatment layer according to an embodiment of the present disclosure may be formed between the first resin layer and the metal layer. To secure adhesion stability between the first resin layer and the metal layer and to suppress the formation of a bubble layer, it is preferable to form the first resin layer after the surface treatment layer is formed on the metal layer.

The surface treatment layer may be formed of a surface treatment composition, and the surface treatment composition may include a main agent, a curing agent, and a solvent.

The main agent may include a polyester-based resin or a polyurethane-based resin. Specifically, the polyester-based resin may include at least one selected from the group consisting of unsaturated polyester resin, saturated polyester resin, ortho polyester resin, iso polyester resin, tere polyester resin, and hydroxyl-functional polyester resin.

In addition, specifically, the polyurethane-based resin may include at least one selected from the group consisting of acrylic polyol, polyester polyol, polyether polyol, caprolactone polyol, polybutadiene polyol, and polyacrylate polyol.

The curing agent may be an isocyanate-based compound, and specifically, the isocyanate-based compound may include, for example, polyisocyanate, an adduct thereof, an isocyanurate-modified product thereof, a carbodiimide-modified product thereof, an allophanate-modified product thereof, a biuret-modified product thereof, and the like. The polyisocyanates may include, specifically, aromatic diisocyanates, such as diphenylmethane diisocyanate (MDI), polyphenylmethane diisocyanate (polymeric MDI), toluene diisocyanate (TDI), hexamethylene diisocyanate (HDI), bis(4-isocyanatecyclohexyl) methane (H12MDI), isophorone diisocyanate (IPDI), 1,5-naphthalene diisocyanate (1,5-NDI), 3,3′-dimethyl-4,4′-diphenylene diisocyanate (TODI), and xylene diisocyanate (XDI); aliphatic diisocyanates, such as tramethylene diisocyanate, hexamethylene diisocyanate, trimethylhexamethylene diisocyanate, and isophorone diisocyanate; alicyclic diisocyanates, such as 4,4′-methylenebis(cyclohexylisocyanate) and isophorone diisocyanate; and the like.

The adduct may include, specifically, adducts added with trimethylolpropane, glycol, or the like to the polyisocyanate. These isocyanate compounds may include preferably polyisocyanates and adducts thereof; more preferably aromatic diisocyanates, adducts thereof, and isocyanurate-modified products thereof; much more preferably MDI, polymeric MDI, TDI, adducts thereof, and isocyanurate-modified products thereof; and particularly preferably adducts of MDI, adducts of TDI, polymeric MDI, and isocyanurate-modified products of TDI. These isocyanate compounds may be used alone, or also used in combination of two or more.

The solvent may include at least one selected from the group consisting of acetate-based compounds, ketone-based compounds, and aromatic hydrocarbon-based compounds.

The acetate-based compound may include at least one selected from the group consisting of methyl acetate, ethyl acetate, propyl acetate, butyl acetate, amyl acetate, hexyl acetate, isopropyl acetate, isobutyl acetate, glycol ether PM acetate, glycol ether EB acetate, and glycol ether DPM acetate.

The ketone-based compound may include at least one selected from the group consisting of methyl ethyl ketone (MEK), acetone, methyl isobutyl ketone (MIBK), cyclohexanone, diacetone alcohol, methyl isoamyl ketone, methyl n-amyl ketone, diethyl ketone, methyl n-propyl ketone, diisobutyl ketone, and methyl n-butyl ketone.

The aromatic hydrocarbon-based compound may include at least one selected from the group consisting of toluene, xylene, ortho-xylene, Solvarex 9A, Solvarex 10A, Solvarex 9LC, Solvarex 10LN, benzene, ethylbenzene, cumene, and styrene.

The surface treatment composition may include 4 to 8 parts by weight of the curing agent and 20 to 50 parts by weight of the solvent, based on 50 to 70 parts by weight of the main agent.

The thickness of the surface treatment layer may be 2 to 10 μm. For example, the thickness of the surface treatment layer may be 2 μm or more, 3 μm or more, 3.1 μm or more, 3.2 μm or more, 3.3 μm or more, 3.4 μm or more, 3.5 μm or more, 10 μm or less, 9 μm or less, 8 μm or less, 7 μm or less, or 5 μm or less. The capillary number value may be included within the range described above so as to be included within the range according to an embodiment of the present disclosure.

The surface treatment layer may be formed on the metal layer with the composition and content of the surface treatment composition described above. The capillary number value of the formed surface treatment layer may be 0.5 to 5. For example, the capillary number value of the surface treatment layer may be 0.5 or more, 0.6 or more, 0.7 or more, 0.8 or more, 0.9 or more, 1.0 or more, 1.1 or more, 1.2 or more, 5.0 or less, 4.5 or less, 4.4 or less, 4.3 or less, 4.2 or less, 4.1 or less, 4.0 or less, 3.9 or less, 3.8 or less, 3.7 or less, 3.6 or less, 3.5 or less, 3.4 or less, 3.3 or less, 3.2 or less, 3.1 or less, or 3.0 or less.

The capillary number is a dimensionless number used in fluid dynamics, indicates the relative importance of viscosity and surface tension, and is defined as a value obtained by dividing the product of the viscosity (μ) and the substrate velocity (V) of a fluid by a surface tension (γ) (Ca=μV/γ) to play a crucial role in understanding and predicting a fluid flow, particularly a fluid behavior at interfaces.

When the capillary number of the surface treatment layer according to an embodiment of the present disclosure is less than the above range, the fluidity of the surface treatment layer may increase excessively, making it difficult to form a uniform coating layer. When the capillary number thereof exceeds the above range, the viscosity of the surface treatment layer may become excessively high, and non-uniformity in the treatment layer occurs, which may deteriorate the adhesion with the first resin layer, and the non-uniformity caused by high surface tension may occur to increase the bubble generation rate between the first resin layer and the metal layer.

That is, the bubble generation rate may be significantly reduced by including the capillary number within the above-described range to provide a chance for bubbles to escape for a sufficient time when forming the surface treatment layer on the metal layer and forming the first resin layer.

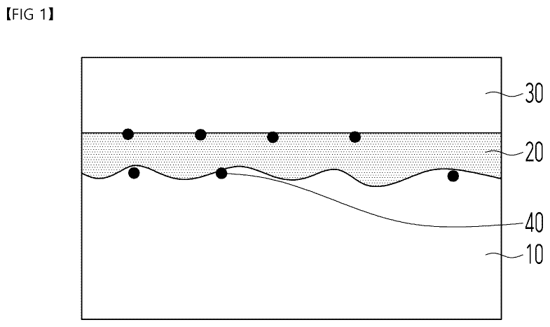

The bubbles 40 may be generated between the metal layer 10 and the surface treatment layer 20, or between the surface treatment layer 20 and the first resin layer 30, as illustrated in FIG. 1, and the bubble generation rate may be calculated as “bubble area/measured total area*100(%)”, and according to one embodiment of the present disclosure, the bubble generation rate may be less than 3%, preferably less than 2%, more preferably less than 1%, and particularly preferably less than 0.5%. When the bubble generation is reduced less than the above-mentioned range, a bonding surface between the first resin layer and the metal layer may be uniform, thereby improving the durability of the produced film for the cell pouch.

In addition, the present disclosure may provide the following manufacturing method to secure the above-mentioned capillary number value.

Specifically, a method for manufacturing a film for a cell pouch of the present disclosure, which includes a first resin layer, a metal layer, and a second resin layer, may include forming a surface treatment layer on the metal layer and forming a first resin layer on the surface treatment layer.

Preferably, in order to secure a capillary number, the method may further include a heat treatment process, after forming the surface treatment layer on the metal layer and before forming the first resin layer. Specifically, the heat treatment process may be performed at a temperature of 60 to 100° C. for 10 to 100 seconds, after applying a surface treatment composition on the metal layer. Through the heat treatment, the base material speed, viscosity, and surface tension of the formed surface treatment layer may be controlled. In particular, since a large amount of solvent is included to secure an appropriate capillary number, the heat treatment may also be required for the reason of increasing the viscosity value of the corresponding surface treatment composition. In addition, the bubble generation rate between the metal layer and the surface treatment layer may be reduced by the heat treatment. Through the heat treatment process within the above range, the film for the cell pouch manufactured may ensure high durability even under harsh conditions, such as 120° C. high-temperature peel stability, long-term reliability evaluation, and the like. Hereinafter, the present disclosure will be described in detail with reference to Examples for specific description. However, Examples according to the present disclosure may be modified in various forms, and it is not interpreted that the scope of the present disclosure is limited to the following Examples. Examples of the present disclosure will be provided for more completely explaining the present disclosure to those skilled in the art.

### EXAMPLES AND COMPARATIVE EXAMPLES

### Example 1

A 4 μm-thick surface treatment layer was formed on a first surface of a 60 μm-thick aluminum foil as a metal layer using a surface treatment composition according to compositions, contents, and conditions shown in Table 1. A 12 μm-thick PET film and a 25 μm-thick nylon film were bonded to each other as a first resin layer, and then a nylon film surface of the first resin layer and a first surface of the aluminum foil faced each other, and then were bonded to each other using a solvent dry lamination process. As a second resin layer, 30 μm-thick extruded polypropylene (PP) and 50 μm-thick casting polypropylene (cPP) faced the second surfaces of the extruded polypropylene (PP) and the aluminum foil to manufacture a film for a cell pouch using a sandwich lamination method.

### Examples 2 to 10 and Comparative Examples 1 to 3

In Examples 2 to 8 and Comparative Examples 1 to 3, films for a cell pouch were manufactured in the same manner as in Example 1, except that the conditions were varied, as shown in Table 1 below.

In the case of Examples 6 to 8 below, films for a cell pouch were manufactured in the same manner as in Example 1, but a surface treatment composition was formed on the metal layer, followed by heat treatment at 70° C. for 20 seconds. Thereafter, the first resin layer was formed.

TABLE 1

| | | Main | | Viscosity | | |
|---|---|---|---|---|---|---|
| | Metal layer | agent/curing | Base material | of surface | Surface tension of | |
| | (Surface | agent/solvent | speed of surface | treatment | surface treatment | |
| | roughness | content | treatment layer | layer | layer | Capillary |
| | Ra/Rz/Rt, μm) | (g) | (m/sec) | (mPa*s) | (mN/m) | number |
| Example 1 | 0.26/2.2/2.6 | 67/7/27.5 | 1.667 | 40 | 24.5 | 2.721 |
| Example 2 | 0.26/2.2/2.6 | 58/6/37.5 | 1.667 | 36 | 24.6 | 2.439 |
| Example 3 | 0.26/2.2/2.6 | 54.5/5.3/42.5 | 1.667 | 22 | 24.3 | 1.509 |
| Example 4 | 0.26/2.2/2.6 | 67/7/18 | 1.667 | 124 | 24.73 | 8.357 |
| Example 5 | 0.26/2.2/2.6 | 52/7/55 | 1.667 | 19 | 24.1 | 1.314 |
| Example 6 | 0.26/2.2/2.6 | 67/7/27.5 | 1.667 | 44 | 24.5 | 2.993 |
| Example 7 | 0.26/2.2/2.6 | 58/6/37.5 | 1.667 | 38 | 24.6 | 2.575 |
| Example 8 | 0.26/2.2/2.6 | 54.5/5.3/42.5 | 1.667 | 24 | 24.3 | 1.715 |
| Comparative | 0.26/2.2/2.6 | 91.5/9/3.5 | 1.667 | 182 | 24.8 | 12.231 |
| Example 1 | | | | | | |
| Comparative | 0.31/2.5/2.9 | 91.5/9/3.5 | 1.667 | 182 | 24.8 | 12.231 |
| Example 2 | | | | | | |
| Comparative | 0.29/2.5/2.8 | 91.5/9/3.5 | 1.667 | 182 | 24.8 | 12.231 |
| Example 3 | | | | | | |

*Main agent: Polyester polyol
*Curing agent: Toluene diisocyanate (TDI)
*Solvent: Ethyl acetate
*Measurement of viscosity: Measured in a 25° C., RH50% environment using a ARES G2 instrument from TA Instrument.
*Measurement of surface tension: Measured in a 25° C., RH50% environment using a surface tension meter Kruss K11/K100.
*Measurement of base material speed of surface treatment layer: Measured at room temperature and absolute humidity of 60% or less using a HIOKI FT3406 digital tachometer. The speed was measured in a flat and uniform section of the base material on a roller, and a portion without wrinkles, foreign matters, and moisture was measured on the surface of the base material to minimize errors.

### EXPERIMENTAL EXAMPLES

### Experimental Example 1: Evaluation of Bubble Generation Rate

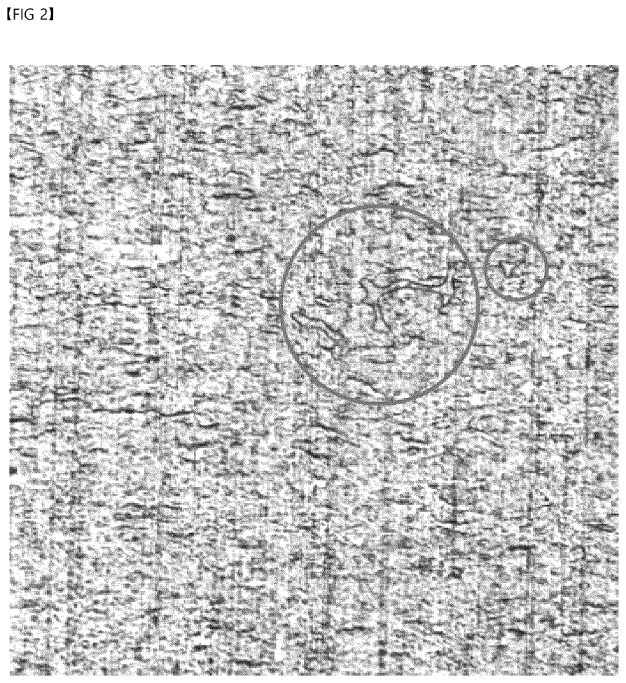

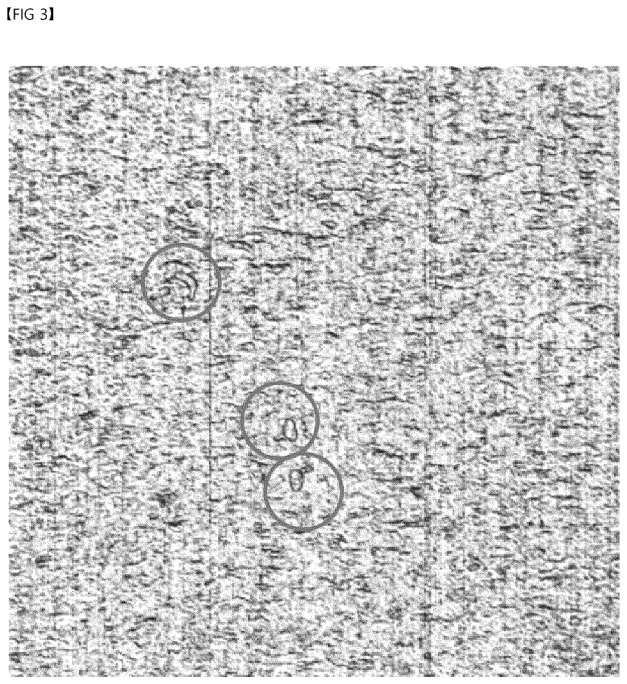

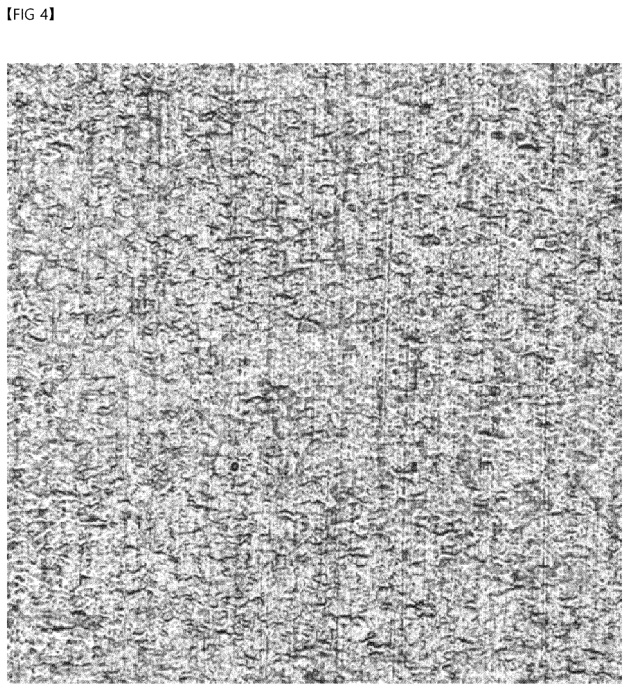

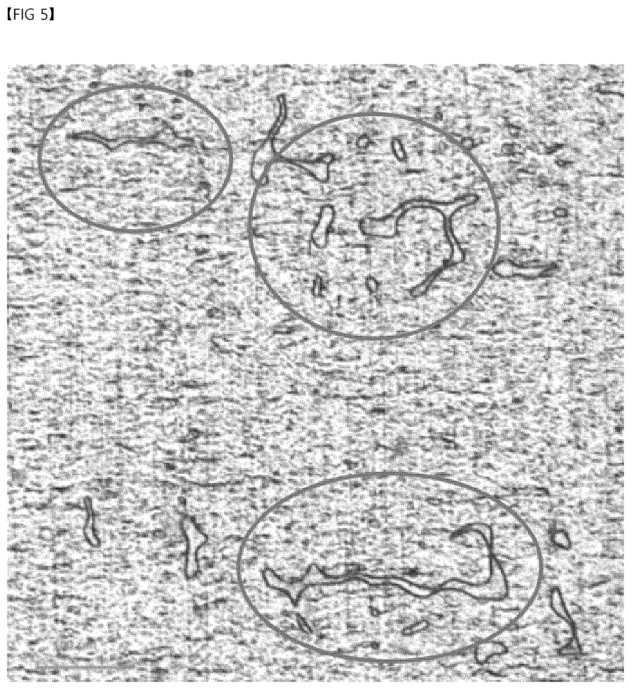

The films for the cell pouch manufactured in Examples and Comparative Examples were cut to sizes of 15 mm×25 mm and photographed using a Leica DM2700 P product to measure the bubble generation rates. The photograph of Example 1 was shown in FIG. 2, the photograph of Example 2 was shown in FIG. 3, the photograph of Example 3 was shown in FIG. 4, and the photograph of Comparative Example 1 was shown in FIG. 5.

Bubble area/Total measured area*100(%)

### Experimental Example 2: Evaluation of Long-Term Reliability

The long-term reliability of the measured Examples and Comparative Examples was evaluated. To replace a battery evaluation, which was required to be performed for a minimum of 6 months to 10 years, the long-term reliability was evaluated under harsh conditions (85° C./85% RH) for 4 weeks. First, each sample from Examples and Comparative Examples was molded in the same size using a test mold (16 cm×9 cm) manufactured by Yulchon Chemical Co., Ltd. Ten molded samples were fabricated and then stored in a 85° C./85% RH condition, and the presence of peeling between the metal layer (aluminum foil) and the first resin layer was visually identified. When floating or peeling was observed, the deformed sample was designated as “NG” among the ten samples.

### Experimental Example 3: Evaluation of Peeling Strength

In the films for the cell pouch manufactured in Examples and Comparative Examples, the peeling strength of the metal layer//the first resin layer of the cell pouch was measured at 25° C. and 120° C. using a chamber-type UTM machine in a high-temperature environment. The mean value and standard deviation were calculated after 10 measurements.

### Experimental Example 4: Evaluation of Coating Uniformity

The weights of the first resin layers applied per unit area of the films for the cell pouch of Examples and Comparative Examples were repetitively measured 10 times, and the mean value and standard deviation were calculated.

The results for Experimental Examples 1 to 4 were shown in Table 2.

TABLE 2

| | Bubble | Long-term | | Peeling strength (25° C.) | | Coating uniformity | |
|---|---|---|---|---|---|---|---|
| | generation | reliability | Peeling strength | (N/15 mm) | | (g/m²) | |
| | rate | NG/sample | (120° C.) | | Standard | | Standard |
| | (%) | number | (N/15 mm) | Mean | deviation | Mean | deviation |
| Example 1 | 0.6 | 2/10 | 6.5 | 15.16 | 0.77 | 3.56 | 0.18 |
| Example 2 | 0.3 | 2/10 | 6.8 | 15.45 | 0.42 | 3.53 | 0.13 |
| Example 3 | 0.1 | 3/10 | 6.9 | 15.76 | 0.2 | 3.55 | 0.11 |
| Example 4 | 1.5 | 5/10 | 6.2 | 15.56 | 0.46 | 3.58 | 0.23 |
| Example 5 | 0.15 | 6/10 | 5.8 | 14.55 | 0.98 | 3.45 | 0.12 |
| Example 6 | 0.45 | 1/10 | 7.3 | 15.26 | 0.85 | 3.58 | 0.19 |
| Example 7 | 0.25 | 0/10 | 7.6 | 15.53 | 0.65 | 3.57 | 0.18 |
| Example 8 | 0.06 | 0/10 | 7.8 | 15.83 | 0.43 | 3.54 | 0.14 |
| Comparative | 3.0 | 8/10 | 5.9 | 15.12 | 0.9 | 3.62 | 0.25 |
| Example 1 | | | | | | | |
| Comparative | 3.3 | 8/10 | 5.8 | 14.95 | 1.05 | 3.6 | 0.33 |
| Example 2 | | | | | | | |
| Comparative | 3.2 | 7/10 | 6.2 | 15.05 | 1.08 | 3.58 | 0.28 |
| Example 3 | | | | | | | |

### EXPLANATION OF REFERENCE NUMERALS AND SYMBOLS

10: Metal layer
20: Surface treatment layer
30: First resin layer
40: Bubbles

What is claimed is:

1. A film for a cell pouch comprising a first resin layer, a metal layer, and a second resin layer, wherein
a surface treatment layer is included between the first resin layer and the metal layer, and
the surface treatment layer has a capillary number of 0.5 to 5.

2. The film for the cell pouch of claim 1, wherein the metal layer satisfies at least one of the following conditions (1) to (3):
(1) a surface roughness (Ra) value of the metal layer of 0.2 μm or greater,
(2) a surface roughness (Rt) value of the metal layer of 1.5 μm or greater, and
(3) a surface roughness (Rz) value of the metal layer of 2.0 μm or greater.

3. The film for the cell pouch of claim 1, wherein a bubble generation rate generated between the first resin layer and the metal layer of the film for the cell pouch is less than 3%.

4. The film for the cell pouch of claim 1, wherein the first resin layer contains at least one of a polyester resin and a polyamide resin.

5. The film for the cell pouch of claim 1, wherein the metal layer contains at least one selected from the group consisting of aluminum (Al), iron (Fe), copper (Cu), nickel (Ni), stainless steel (SUS), tin (Sn), zinc (Zn), indium (In), tungsten (W), titanium (Ti), and invar (INVAR).

6. The film for the cell pouch of claim 1, wherein the second resin layer contains a resin including at least one selected from the group consisting of polyolefins, polybutylenes, ethylene copolymers, propylene copolymers, polyesters, polyamides, polycarbonates, fluorines, silicones, cyclic polyolefins, carboxylic acid-modified cyclic polyolefins, acrylics, ethylene-propylene-diene-monomer rubber (EPDM), and polyolefin ketone copolymers.

7. The film for the cell pouch of claim 1, wherein the surface treatment layer is formed of a surface treatment composition.

8. The film for the cell pouch of claim 7, wherein the surface treatment composition includes a main agent, a curing agent, and a solvent.

9. The film for the cell pouch of claim 8, wherein the main agent contains a polyester-based resin or a polyurethane-based resin.

10. The film for the cell pouch of claim 8, wherein the curing agent contains an isocyanate-based compound.

11. The film for the cell pouch of claim 8, wherein the solvent contains at least one selected from the group consisting of acetate-based compounds, ketone-based compounds, and aromatic hydrocarbon-based compounds.

12. The film for the cell pouch of claim 8, wherein the surface treatment composition includes 4 to 8 parts by weight of the curing agent and 20 to 50 parts by weight of the solvent, based on 50 to 70 parts by weight of the main agent.

13. A method for manufacturing a film for a cell pouch comprising a first resin layer, a metal layer, and a second resin layer, the method comprising:
forming a surface treatment layer on the metal layer; and
forming a first resin layer on the surface treatment layer,
wherein the surface treatment layer has a capillary number of 0.5 to 5.

14. The method of claim 13, wherein the surface treatment layer is formed of a surface treatment composition, and
the surface treatment composition includes a main agent, a curing agent, and a solvent.

15. The method of claim 14, wherein the surface treatment composition includes 4 to 8 parts by weight of the curing agent and 20 to 50 parts by weight of the solvent, based on 50 to 70 parts by weight of the main agent.

16. The method of claim 14, wherein the forming of the surface treatment layer on the metal layer comprises applying a surface treatment composition onto the metal layer and performing heat treatment at a temperature of 60 to 100° C. for 10 to 100 seconds.
